(19) United States
(12) Patent Application Publication
(10) Pub. No.: US 2024/0409130 A1
(43) Pub. Date: Dec. 12, 2024

(54) RAIL VEHICLE TRACTION SYSTEM AND ASSOCIATED RAIL VEHICLE

(71) Applicant: ALSTOM Holdings, Saint-Ouen-sur-Seine (FR)

(72) Inventor: Patrick JEANBLANC, SERMAMAGNY (FR)

(21) Appl. No.: 18/735,016

(22) Filed: Jun. 5, 2024

(30) Foreign Application Priority Data
Jun. 6, 2023 (FR) 2305662

(51) Int. Cl. B61C 7/04

(52) U.S. Cl. CPC B61C 7/04

(57) ABSTRACT

A traction system of a rail vehicle including an electric traction motor, a traction battery having a traction voltage with a rated value greater than or equal to 800 V, the traction battery being connected to the electric traction motor. The traction system further comprises an internal combustion engine and a starting device configured to start the internal combustion engine, the starting device being connected to the traction battery by a power supply connection arranged to supply the starting device with a starting voltage strictly lower than the traction voltage.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to traction system for a rail system. The disclosure further relates to a rail vehicle comprising such a traction system. The disclosure relates to the field of rail vehicles, more particularly hybrid rail vehicles. Hybrid rail vehicles comprise, for traction, an internal combustion engine and an electric motor powered e.g. by a high-capacity traction battery.

### BACKGROUND

To start the internal combustion engine, some rail vehicles comprise an electric starter. The starter is powered by a battery dedicated to the powering of the starter. Furthermore, such rail vehicles comprise e.g. an on-board battery for powering an on-board network.

However, it is not possible, for various reasons, to use the on-board battery to power the starter. Indeed, during the supply of power to the starter, a strong current flows through the starter, resulting in a drop in the voltage of the battery powering the starter. Some on-board equipment does not tolerate such a voltage drop, and the large voltage drop results e.g. in a malfunction, or even damage to the equipment. Therefore, the starter motor should not be powered by the on-board battery, but by the dedicated battery.

Such a hybrid rail vehicle, comprising an internal combustion engine and an electric motor for traction, is relatively heavy given the large number of systems and batteries.

### SUMMARY

A goal of the disclosure is then to obtain a traction system for a rail vehicle comprising an electric traction motor and an internal combustion engine, which is lighter and/or which comprises a reduced number of components.

To this end, the subject matter of the present disclosure is a traction system for a rail vehicle comprising an electric traction motor, a traction battery having a traction voltage having a rated value greater than or equal to 800 V, the traction battery being connected to the electric traction motor, the traction system further comprising an internal combustion engine and a starting device configured to start the internal combustion engine, the starting device being connected to the traction battery by a power supply connection arranged to power the starting device with a starting voltage strictly lower than the traction voltage.

Indeed, the traction system according to the disclosure serves to power the starting device of the internal combustion engine by means of the traction battery which is already present in the traction system. More particularly, arranging the power supply connection so as to power the starting device with the starting voltage makes it possible to obtain a particularly light traction system. The traction system according to the disclosure makes it possible in particular to dispense with a battery dedicated exclusively to powering the starting device.

Also, the use of the traction battery makes it easier to recharge the batteries, because no battery dedicated solely to powering the starting device is recharged.

Finally, the use of the traction battery with a voltage of at least 800 V becomes possible in rail vehicles, because the capacity of the battery and the voltage thereof are very high. Consequently, the power supply to the starting device has no or only very little influence on the traction voltage of the traction battery.

According to other advantageous aspects of the disclosure, the traction system comprises one or a plurality of the following features, taken individually or according to all technically possible combinations:
the starting voltage is comprised between 10 and 30 V;
the traction battery comprises at least one bank of batteries comprising a plurality of battery cells connected in series, preferably the traction battery comprising a plurality of banks of batteries, connected parallel to each other;
each battery cell has a rated voltage substantially equal to 1.2 V;
the power supply connection comprises a first cable connecting the starting device to an intermediate terminal of the traction battery, the intermediate terminal being electrically connected to one of the bank(s) of batteries, called a starting power supply bank, between two adjacent battery cells of the plurality of battery cells connected in series of said starting power supply bank;
the power supply connection comprises a second cable connecting the starting device to one end of said starting power bank, the end preferably having a voltage substantially equal to zero with respect to the chassis ground;
the traction battery comprises two voltage terminals having the traction voltage therebetween and being connected to the electric traction motor;
the traction battery comprises at least one switch configured to electrically separate one of the voltage terminals of the bank(s) of batteries, and/or wherein the traction battery comprises, for the or each battery bank, a fuse or switch configured to electrically separate the bank of batteries from one of the voltage terminals;
the traction battery is a lithium-ion battery;
the traction battery comprises a controller configured to enable a powering of the starting device by the starting voltage when the traction voltage is above a predetermined threshold, and/or when a temperature of the traction battery is within a predetermined temperature range;
the starting device comprises a starting motor configured to start the internal combustion engine.

A further subject matter of the present disclosure is a rail vehicle comprising a traction system as defined hereinabove.

According to an advantageous aspect of the disclosure, the rail vehicle further comprises an on-board battery, distinct from the traction battery, configured to power an on-board network of the rail vehicle.

### BRIEF DESCRIPTION OF THE DRAWINGS

The features and advantages of the disclosure will appear upon reading the following description, given only as an example, but not limited to, and making reference to the enclosed drawing, wherein:

FIG. 1 is a schematic view of a part of a rail vehicle comprising a traction system according to the disclosure.

### DETAILED DESCRIPTION

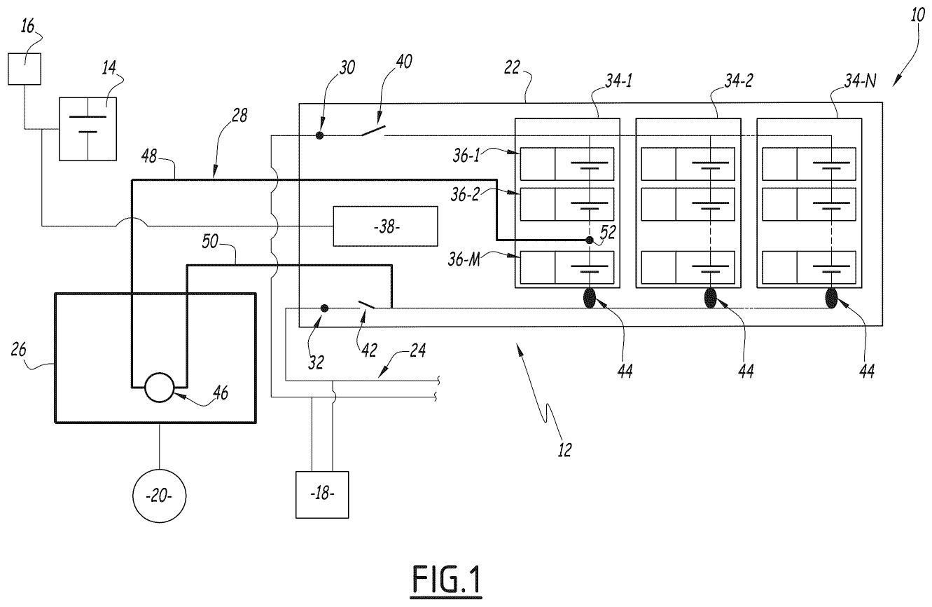

With reference to FIG. 1, a rail vehicle 10 comprises a traction system 12 configured to pull the rail vehicle 10.

The rail vehicle 10 is in particular a hybrid vehicle, comprising in particular two traction motors of different types.

The rail vehicle 10 further comprises e.g. an on-board battery 14 and an on-board network 16. The on-board battery 14 is in particular distinct from the traction system 12. The on-board battery 14 is in particular configured to supply the on-board network 16, in particular by a low voltage, such as a voltage substantially equal to 24 V.

The traction system 12 comprises an electric traction motor 18, an internal combustion engine 20, a traction battery 22, a traction bus 24, a starting device 26 and a power supply connection 28.

The electric traction motor 18 is configured to pull the rail vehicle. More particularly, the electric traction motor 18 is connected to the traction battery 22 by the traction bus 24.

The electric traction motor 18 is configured to be supplied with a traction voltage from the traction battery 22. As an optional addition, the electric traction motor 18 is configured to operate in recuperating mode, by supplying the traction battery 22 with electrical power.

The internal combustion engine 20 is e.g. a diesel engine. According to one example, the traction system 12 comprises a plurality of internal combustion engines 20.

The internal combustion engine 20 is e.g. configured to pull the rail vehicle 10 and/or forms a generator configured to electrically power the traction battery 22.

The internal combustion engine 20 is configured to be started by the starting device 26.

The traction battery 22 is preferably a lithium-ion battery.

The traction battery is more particularly configured to supply a direct current. The traction battery 22 has more particularly a capacity of at least 50 kWh, preferably at least 100 kWh, else preferably several hundreds of kWh.

The traction battery 22 has traction voltage. The traction voltage has a rated value greater than or equal to 800 V. Preferably, the rated value is comprised between 800 V and 1000 V.

“Rated value” refers to a value of the predetermined voltage, more particularly when the traction battery 22 has a charging state higher than a predetermined lower threshold.

The traction voltage has a value strictly greater than a value of a starting voltage with which the starting device 26 is supplied to start the internal combustion engine 20. Preferably, the traction voltage has an order of magnitude different from an order of magnitude of the value of the starting voltage.

Preferably, the traction battery 22 has a very high electrical charge, more particularly of one or more orders of magnitude greater than an order of magnitude of an electrical charge used by the starting device 26 to start the internal combustion engine 20.

As a result therefrom, the traction battery 22 can be used without risking e.g. a significant drop in the traction voltage.

The traction battery 22 comprises more particularly two voltage terminals 30, 32. The two voltage terminals 30, 32 have the traction voltage therebetween. More particularly, the two voltage terminals 30, 32 are connected to the electric traction motor 18.

The traction battery 22 further comprises at least a bank of batteries 34. Preferably, the traction battery 22 comprises a plurality of banks of batteries 34 connected in parallel to each other, e.g. N banks of batteries. The number N is greater than or equal to 2. Preferably, the number N is greater than or equal to 10, else more preferably greater than or equal to 12.

For example, with reference to FIG. 1, the traction battery 22 comprises the bank of batteries 34-1, the bank of batteries 34-2 and the bank of batteries 34-N.

Each bank of batteries 34 is preferably identical with respect to each other.

Each end of a corresponding bank of batteries 34 is electrically connected to one of the two voltage terminals 30, 32. Preferably, each end of a bank of batteries 34 is directly connected to the respective voltage terminal, i.e. without any intermediate element between the end and the respective terminal 30, 32 other than a fuse and/or a switch.

Each bank of batteries 34 comprises a plurality of battery cells 36 connected in series, more particularly between the ends of the respective bank of batteries 34. For example, with reference to FIG. 1, each bank of batteries 34 comprises M battery cells 36. The number M is at least 2, preferably at least 10, else preferably at least 20 or equal to 20.

According to one example, the traction battery 22 comprises twelve banks of batteries 34, and each bank of batteries 34 comprises twenty battery cells 36.

For example, the bank of batteries 34-1 comprises the battery cell 36-1, the battery cell 36-2 and the battery cell 36-M. Preferably, each bank of batteries 34 comprises the same number of battery cells 36.

For example, each battery cell 36 has a voltage with a predetermined rated value, e.g. substantially equal to 1.2 V. In the present example, to obtain the traction voltage greater than or equal to 800 V, each bank of batteries 34 comprises, e.g. more than 650 battery cells 36.

According to one example, each battery cell 36 has a rated capacity equal to 60 Ah.

The traction battery 22 further comprises e.g. a controller 38 configured to control the operation of the traction battery 22. More particularly, the controller 38 is connected to each battery cell 36 to control e.g. the voltage thereof and/or the temperatures of the battery cells 36.

According to one example, the controller 38 is configured to authorize a supply of power to the starting device 26 only when the traction voltage is higher than a predetermined threshold.

According to one example, the controller 38 is configured to authorize a supply of power to the starting device 26 only when a temperature of the traction battery 22, and more particularly of the battery cells 36, is comprised within a predetermined range of temperatures.

The traction battery 22 further comprises e.g. at least one switch 40, 42 configured to electrically separate one of the voltage terminals 30, 32 from the bank(s) of batteries 34. For example, with reference to FIG. 1, the traction battery 22 comprises a first switch 40 configured to electrically separate the voltage terminal 30 from the banks of batteries 34, and a second switch 42 configured to electrically separate the voltage terminal 32 from the banks of batteries 34. The or each switch 40, 42 is e.g. controlled by the controller 38.

According to one example, the or each switch 40, 42 is integrated into a switch cabinet. According to one example, the or each switch 40, 42 is a contactor.

Preferably, the or each switch 40, 42 is configured to be open when the starting device 26 starts the internal combustion engine 20.

For example, the traction battery 22 further comprises, for the or each bank of batteries 34, at least one fuse 44 configured to separate the bank of batteries 34, preferably only the bank of batteries 34, of the voltage terminal 32 when a current exceeds a predetermined threshold, while maintaining in particular a connection of the other banks of batteries 34 to the voltage terminal 32. In the present example, the voltage terminal 32 preferably has a voltage substantially equal to zero with respect to the chassis round or to the earth.

According to one example, the traction battery 22 comprises, for the or each bank of batteries 34, a specific switch (not shown) configured to separate the bank of batteries 34 from one of the voltage terminals 30, 32, preferably only the bank of batteries 34, while keeping in particular a connection of the other banks of batteries 34 to the corresponding voltage terminal 30, 32.

The traction bus 24 connects more particularly the voltage terminals 30, 32 to the electric traction motor 18 and/or to a voltage source (not shown) for recharging the traction battery 22. According to one example, the voltage source is a recharging terminal.

As an optional addition (not shown), the traction bus 24 also connects the voltage terminals 30, 32 to the internal combustion engine 20 for recharging the traction battery 22, when the internal combustion engine 20 is operating as a generator.

The start device 26 is configured to start the internal combustion engine 20. For example, the starting device 26 is configured to be supplied with a current comprised between 1500 A and 2000 A for starting the internal combustion engine 20. Preferably, the starting device 26 is configured to start the internal combustion engine 20 when same is powered for a period of less than or equal to 10 s. More particularly, the starting device 26 is configured to use, for starting the internal combustion engine 20, an electrical energy which is very low relative to the total energy of the traction battery 22, in particular a load of several orders of magnitude lower than the total energy.

The starting device 26 comprises e.g. a starting motor 46, which is in particular an electric motor configured to transmit a mechanical torque to the internal combustion engine 20 in order to start same.

In addition, the starting device 26 comprises an electrical circuit and/or a controller (not shown) configured to control the operation of the starting motor 46.

According to the disclosure, the power supply connection 28 is arranged to supply the starting device 26, and more particularly the starting motor 46, with the starting voltage strictly lower than the traction voltage.

“Power supply connection 28 arranged to power the starting device” means more particularly that the power supply connection 28 forms a voltage divider. More particularly, the power supply connection 28 is arranged to derive a voltage strictly lower than the traction voltage, namely the starting voltage, from the traction voltage which is present in particular between two ends of each bank of batteries 34.

For example, the starting voltage is comprised between 10 V and 30 V, preferably substantially equal to 12 V or 24 V.

Preferably, the power supply connection 28 comprises a first cable 48 and a second cable 50.

The first cable 48 connects the starting device 26 to an intermediate terminal 52 of the traction battery 22. The intermediate terminal 52 is electrically connected to the or one of the bank(s) of batteries 34, called the starting power supply bank, between two battery cells 36 adjacent to the starting power supply bank. In the example shown in FIG. 1, the starting power supply bank is the bank of batteries 34-1.

The second cable 50 is preferably electrically connected to one end of the starting power supply bank.

For example, the second cable 50 is electrically connected to the end of the starting power supply bank having a voltage substantially equal to zero with respect to the chassis round or to the ground. It is thereby possible, more particularly, to power the starting device 26 without providing electrical insulation between the traction battery 22 and the starting device 26.

For example, the second cable 50 is connected to a bus connecting the respective ends of all the banks of batteries 34, connected in parallel, to the voltage terminal 32, in particular when the second switch 42 is closed.

For example, the second cable 50 is connected to a section of the bus which connects the second switch 42 to the ends of the set of banks of batteries 34 or to the fuses 44 arranged at the ends of the banks of batteries 34. Preferably, such section of said bus has no other electrical elements or connections to other electrical elements, such as capacitors.

When the traction battery 22 has no second switch 42, the second cable 50 is preferably connected to a section of a bus which connects, without intermediate elements, the voltage terminal 32 at the ends of the set of banks of batteries 34 or at the fuses 44 arranged at the ends of the banks of batteries 34.

The arrangement of the first and second cables 48, 50 thereby forms a voltage divider.

According to examples not shown, the first cable 48 and/or the second cable 50 comprises at least one resistor and/or at least one fuse.

It can be understood that the present disclosure has many advantages.

More particularly, the fact of using the traction battery 22 having a traction voltage with a value greater than or equal to 800 V for starting the internal combustion engine 20 makes it possible to dispense with a dedicated battery for powering the starting device 26. The above is particularly advantageous because the traction battery 22 has a high voltage value and preferably a high capacity. For example, for the above reasons, such a powering of the starting device 26 is not possible from the on-board battery 14.

In addition, a variation in traction voltage of the traction battery 22 during the powering of the starting device 26 is very small given the high capacity of the traction battery 22.

The use of the on-board battery 14, distinct from the traction battery 22, serves to protect on-board equipment, in particular the on-board network 16, some elements of which are sensitive to a variation in the supply voltage. For example, when the traction voltage varies, in particular when the starting device 26 is powered up by powering the traction battery 22, the equipment of the on-board network 16 is not affected by the variation, even if the variation of the voltage is small.

What is claimed is:

1. A traction system of a rail vehicle comprising an electric traction motor, a traction battery having a traction voltage with a rated value greater than or equal to 800 V, the traction battery being connected to the electric traction motor, wherein the traction system further comprises an internal combustion engine and a starting device configured to start the internal combustion engine, the starting device being connected to the traction battery by a power supply connection arranged to supply the starting device with a starting voltage strictly lower than the traction voltage.

2. The traction system according to claim 1, wherein the starting voltage is comprised between 10 and 30 V.

3. The traction system according to claim 1, wherein the traction battery comprises at least one bank of batteries comprising a plurality of battery cells connected in series.

4. The traction system according to claim 3, wherein the power supply connection comprises a first cable connecting the starting device to an intermediate terminal of the traction battery, the intermediate terminal being electrically connected to one of battery banks, referred to as a starting power bank, between two adjacent battery cells of the plurality of battery cells connected in series to said starting power bank.

5. The traction system according to claim 4, wherein the power supply connection comprises a second cable connecting the starting device to an end of said starting power bank.

6. The traction system according to claim 5, wherein the end of said starting power bank has a voltage substantially equal to zero with respect to chassis ground.

7. The traction system according to claim 3, wherein the traction battery comprises a plurality of banks of batteries connected parallel to each other.

8. The traction system according to claim 1, wherein the traction battery comprises two voltage terminals having the traction voltage therebetween and being connected to the electric traction motor.

9. The traction system according to claim 8, wherein the traction battery comprises at least one bank of batteries, wherein the traction battery comprises at least one switch configured to electrically separate one of said two voltage terminals from the at least one bank of batteries, and/or wherein the traction battery comprises, for the or each bank of batteries, a fuse or switch configured to electrically separate the at least one bank of batteries from one of said two voltage terminals.

10. The traction system according to claim 1, wherein the traction battery comprises a controller configured to permit a powering of the starting device by the starting voltage when the traction voltage is higher than a predetermined threshold, and/or when a temperature of the traction battery is comprised within a predetermined range of temperatures.

11. A rail vehicle comprising a traction system according to claim 1.

12. The rail vehicle according to claim 11, further comprising an on-board battery, distinct from the traction battery, configured to power an on-board network of the rail vehicle.
